(19) United States
(12) Patent Application Publication
(10) Pub. No.: US 2011/0098613 A1
(43) Pub. Date: Apr. 28, 2011

(54) Massage Device and Control Methods

(75) Inventors: Jonathan Thomas, San Francisco, CA (US); John Pelochino, Redwood City, CA (US); Akbar Dhanaliwala, San Francisco, CA (US); Brian Krieger, San Francisco, CA (US); Tae Kim, San Francisco, CA (US)

(73) Assignee: MINNA LIFE LLC, San Francisco, CA (US)

(21) Appl. No.: 12/909,773

(22) Filed: Oct. 21, 2010

Related U.S. Application Data
(60) Provisional application No. 61/254,648, filed on Oct. 23, 2009.

(51) Int. Cl. A61H 1/00

(52) U.S. Cl. 601/46

(57) ABSTRACT

Provided are a system and method for controlling a device through changes in a pressure of a deformable chamber such as may be controlled by a user through a user's hand and/or body. In one example, a device with a deformable chamber detects pressure level changes from a baseline and modifies output parameters including modifications on the playback of stored patterns. In another example, a massage device with a deformable chamber records the most recent pressure level changes in a sequence, interprets the pressure level sequence as a sequence of power levels to a vibratory motor, and repeats back the interpretation until a further pressure input is received above a baseline. In another example, the massage device interprets the currently input sequence of pressure levels in real-time into a sequence of power levels delivered to the vibratory motor.

### CROSS-REFERENCE TO RELATED APPLICATIONS

The present application claims the benefit of Provisional U.S. Application Ser. No. 61/254,648, filed Oct. 23, 2009 and entitled “Personal Pleasure Device,” the disclosure of which is incorporated herein by reference.

### FIELD OF THE TECHNOLOGY

At least some embodiments of this disclosure relate in general to devices and control systems and methods of the same.

### BACKGROUND

A device may use control systems and methods that receive input from a user of the device.

### SUMMARY OF THE DESCRIPTION

Provided are a system and method for controlling a device through changes in a pressure of a deformable chamber such as may be controlled by a user. In one example, a device with a deformable chamber detects pressure level changes from a baseline and modifies output parameters including modifications on the playback of stored patterns. In another example, a massage device with a deformable chamber records the most recent pressure level changes in a sequence, interprets the pressure level sequence as a sequence of power levels to a vibratory motor, and repeats back the interpretation until a further pressure input is received above a baseline. In another example, the device interprets the currently input sequence of pressure levels in real-time into a sequence of power levels delivered to an actuator.

In one aspect, the disclosure describes an apparatus including a deformable surface portion and a deformable chamber connected with the deformable surface portion. The apparatus includes a pressure sensor configured to detect a pressure level of the deformable chamber, a vibratory element, and a control circuit adapted to control power delivered to the vibratory element based on the pressure level.

In another aspect, the disclosure describes an apparatus including a pressure sensor configured to detect a pressure level and a vibratory element. The apparatus includes a control circuit adapted to control power delivered to the vibratory element based on the pressure level, wherein the pressure level is a first pressure level of a sequence of pressure levels and wherein the control circuit is further adapted to store pressure level sequence information in a memory.

In another aspect, the disclosure describes a method including sensing a sequence of pressure levels within a deformable chamber of a vibratory device, and in response to sensing the sequence, controlling power to a vibratory element of the vibratory device with a power sequence based on the sequence of pressure levels. The method includes, after sensing the sequence of pressure levels, sensing a pressure level equal to a predetermined level, and in response to on sensing the pressure level equal to the predetermined level, repeating the step of controlling the power to the vibratory element of the vibratory device with the power sequence.

Other embodiments and features of the present disclosure will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIGS. 1A-1B show an exemplary device according to an embodiment of the present disclosure.

FIG. 2 shows a representation of an exemplary configuration of a pressure sensor and deformable chamber for an apparatus according to an embodiment of the present disclosure.

FIG. 3 shows a schematic representation of an exemplary control circuit for an apparatus according to an embodiment of the present disclosure.

FIG. 4 shows exemplary control of vibratory element of massage device based on pressure level input.

FIG. 5 shows exemplary control of vibratory element of massage device based on stored pressure level information and/or based on current pressure level input.

FIG. 6 shows exemplary control of power delivered to a vibratory element of a massage device based on current pressure level input and delayed versions of recent pressure level input.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one. Reference in this specification to “one embodiment” or “an embodiment” or the like means that a particular feature, structure, or characteristic described in connection with the embodiment is included in at least one embodiment of the disclosure. The appearances of the phrase “in one embodiment” or the like in various places in the specification are not necessarily all referring to the same embodiment, nor are separate or alternative embodiments mutually exclusive of other embodiments. Moreover, various features are described that may be exhibited by some embodiments and not by others.

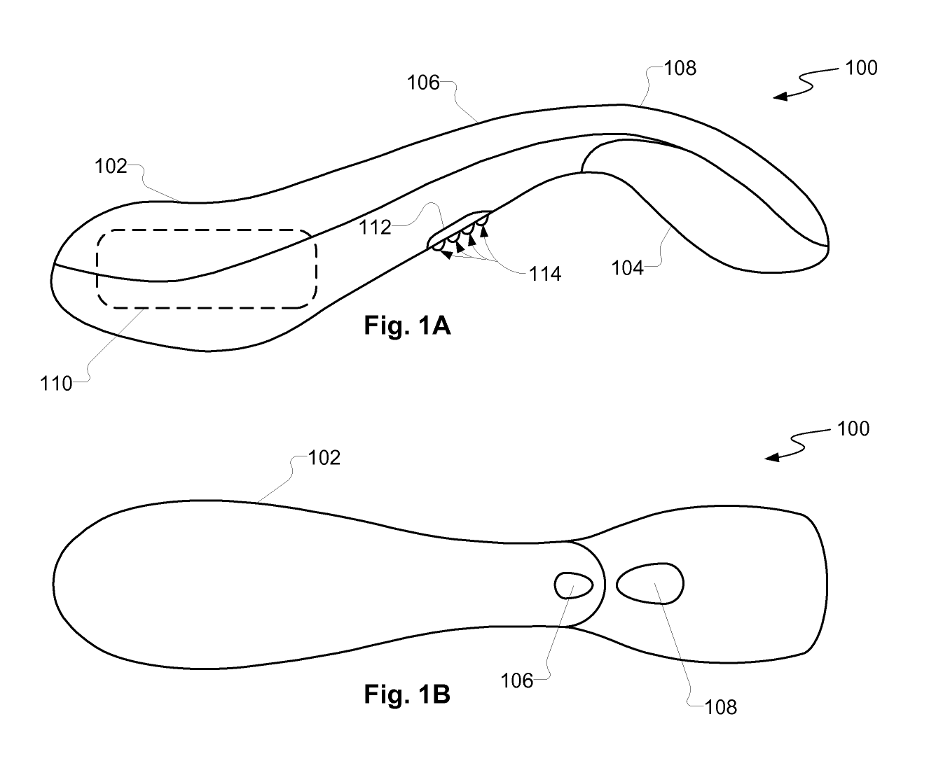

FIG. 1A shows an exemplary device 100 according to an embodiment of the present disclosure. The device includes a body 102 with portion that includes a deformable chamber 104. In one embodiment, the deformable chamber 104 is located on an end of the device 100. In another embodiment, the deformable chamber 104 is located on another portion of the device 100. In another embodiment, the deformable chamber 104 is located on all or substantially all of the device 100.

In one embodiment, the device 100 may be a vibration device used in connection with pleasure, massage, or therapeutic vibration purposes for a person or other living entity. In one embodiment, the disclosure herein of a massage device as an exemplary system and method for controlling an actuator may be used as a handheld, body-held and/or hand-operated or body-operated control system or method for another device. The device may be used in other contexts and industries, such as computer/video game controllers, powered toothbrushes, power tools, lighting, flashlights, water (e.g., faucet, pipe) temperature/flow controllers, home/car climate controllers, medical or dental equipment, vehicle or equipment brake/throttle controllers, volume/station/function/power controllers for music/media players, bite switch, or device for controlling a wheelchair, prosthetics, or a mobility-aiding device.

In one embodiment, the deformable chamber 104 is located in an area of the device 100 intended or adapted to be controlled by a user's hand. In another embodiment, the deformable chamber 104 is located in an area of the device 100 intended to be contacted by another part of the user's body or inserted into the user.

In one embodiment, the device includes additional control interfaces, such as buttons 106 and 108. In one embodiment, the buttons 106 and 108 are push buttons. In another embodiment, the device includes other control interfaces, in addition to or instead of buttons 106 and 108.

In one embodiment, the device 100 includes an interface 112, such as a communications and charging interface, with a plurality of contacts 114. In another embodiment the device 100 includes an interface 112 that includes wireless components or is entirely wireless. In one embodiment, the interface 112 conforms to a power standard, a communications standard, and/or a combination thereof. For example, the interface 112 may conform to a Universal Serial Bus (USB) standard. In another embodiment, the interface 112 uses a proprietary or custom specification. The interface may use systems or methods to ensure solid connections, such as magnetic elements to aid alignment or connectivity.

In one embodiment, the device 100 includes one or more actuators or vibratory elements 110 that may be controlled to affect the actuation or vibration of one or more portions of the device 100. In one embodiment, the device 100 has one vibratory element 110. For example, a massage device 100 may have a single vibratory element 110 that is effective in vibrating the entire body of the massage device 100. As another example, a massage device 100 may have more than one vibratory element 110. In one embodiment, the massage device 100 has a first vibratory element 110 located in one portion of the massage device and another vibratory element 110 located in a second portion of the device. For example, a first and second vibratory element 110 may be configured to provide contrasting, overlapping, and/or cumulative vibrational behavior in the massage device 100 that affects the entire body of the massage device. As another example, a first and second vibratory element 110 may be configured to provide isolated or separated vibrational behaviors to different portions of the body of the massage device 100.

In one embodiment, the device 100 is a massage device and has a vibratory element 110 located in a portion of the massage device opposing the deformable chamber 104, such as on another end of the exemplary massage device 100. In another embodiment, the device 100 is a massage device and has a vibratory element 110 located in a portion of the massage device adjacent to or containing the deformable chamber 104.

FIG. 1B shows another view of an exemplary device according to an embodiment of the present disclosure. A top view of the device 100 shows one embodiment of the position and style of additional control interfaces 106, 108 of the device. In one embodiment, control interfaces 106, 108 are push buttons. In another embodiment, control interfaces 106, 108 are any combination of buttons, switches, rockers, and/or dials. In one embodiment, push button 106 is a power button allowing the device to be turned on and off. In another embodiment, push button 108 is a mode button allowing the operation of the device to be changed between modes, as described further herein.

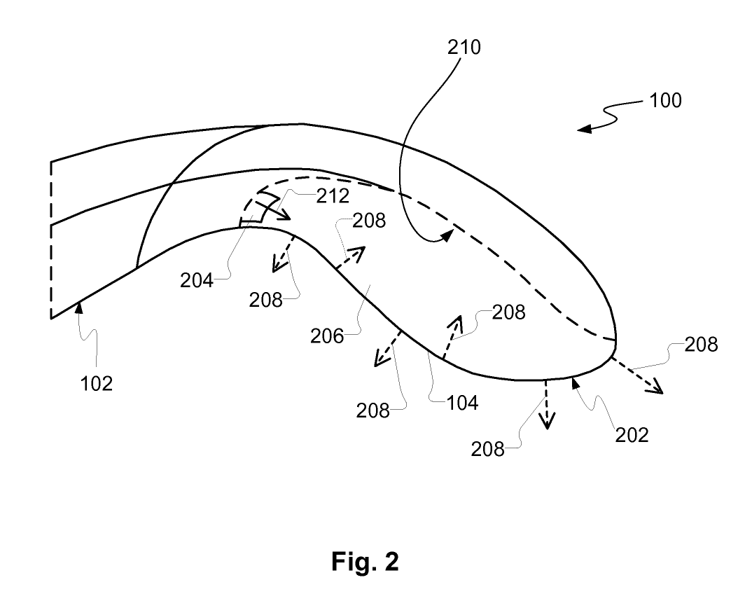

FIG. 2 shows a representation of an exemplary configuration of a sensor 204 and a deformable chamber 104 for an apparatus according to an embodiment of the present disclosure. In one embodiment, the deformable chamber 104 is located near an end of the elongate device 100 and located on a ventral side of the device. In one embodiment, the deformable chamber 104 defines a space 206 between an exterior surface covering 202 of the deformable chamber 104 and an interior surface 210 of the deformable chamber. In one embodiment, the exterior surface covering 202 is a flexible membrane, such as silicone or other elastomer. In one embodiment, the exterior surface covering 202 of the deformable chamber 104 is configured with a continuous transition to the rest of the exterior surface of the body 102 of the device 100. For example, the exterior surface covering 202 and the exterior covering of the rest of the body 102 may be a single covering of the device 100. In another embodiment, the exterior surface covering 202 of the deformable chamber may have a discontinuous junction with the rest of the covering of the body 102 of the device. In another embodiment, the deformable chamber 104 may be separated from the body 102 of the device.

In one embodiment, the space 206 is filled with a fluid. For example, the space 206 may be filled with a gas, such as a noble gas, air, or some mixture thereof. In another embodiment, the space 206 is filled with a solid. For example, the space 206 may be filled with a deformable and/or plastic solid, such as a gel or polymer. In another embodiment, the space 206 is filled with a liquid. In another embodiment, the space 206 is filled with an incompressible or largely-incompressible solid or liquid, such as water or oil.

The device 100 includes a sensor 204 in contact with (e.g., located within, with contacting surfaces) the deformable chamber 104. In one embodiment, the sensor 204 is a pressure sensor adapted to measure a pressure level within the deformable chamber 104, such as an average pressure in the space 206. For example, the pressure sensor may be adapted to measure a change in pressure from a baseline pressure of a compressible fluid in the deformable chamber to another pressure (e.g., a higher pressure due to a decrease in volume of the space 206). In one embodiment, the pressure sensor 204 has an axis 212 along which the sensor measures a force or pressure. In another embodiment, the pressure sensor 204 is capable of measuring a force or pressure on multiple axes or in multiple directions.

In another embodiment, the sensor 204 is a flow sensor adapted to measure the flow of a fluid, liquid or solid (e.g., deformable solid, plastic solid) past or through the sensor. For example, the sensor 204, when configured as flow sensor, may be positioned near or within an outlet to the deformable chamber 104 and may be adapted to measure an amount of material flowing from the deformable chamber to another chamber in the device.

In one embodiment, the interior surface 210 of the deformable chamber 104 is an interior surface of the body 102. For example, the body 102 may be constructed with a rigid frame covered by a soft layer, such as silicone, and the interior surface 210 may be formed by a convex portion of body covered by a exterior surface covering 202, thus forming the space 206 there-between. In one embodiment, the interior surface 210 of the deformable chamber 104 is a flexible surface. In one embodiment, the exterior surface covering 202 of the deformable chamber may surround the space 206, thereby allowing deformation from opposite sides of the deformable chamber 104, such as the dorsal and ventral sides of an elongate device 100.

In one embodiment, the exterior surface covering 202 has surface normals 208 on both an interior and exterior surface of the exterior surface covering 202. In one embodiment, the exterior surface covering 202 has a relatively constant thickness and the surface normals 208 of the interior and exterior surfaces in the same area are anti-parallel. In another embodiment, the surface normals 208 of the interior and exterior surfaces in the same area are not parallel or anti-parallel due to, for example, variations in the thickness of the exterior surface covering 202.

In one embodiment, the deformable chamber 104 is adapted to create a pressure change in the space 206 based on a deformation of the deformable chamber 104 from a first deformed state (e.g., an undeformed state) to a second deformed state. For example, the deformable chamber 104 may transform a force on the exterior surface covering 202 into a deformation of the deformable chamber 104 (e.g., from a first deformed state to a second deformed state) and an increase of pressure above a baseline value. In one embodiment, the force on the exterior surface covering 202 is along a surface normal 208. In another embodiment, the force on the exterior surface covering 202 is at an angle to a surface normal 208. For example, the force may be applied on a portion of the exterior surface covering 202 and the force may be on a vector that is neither parallel nor anti-parallel to any surface normal 208 on the exterior surface covering in its undeformed state. In another embodiment, the force on the exterior surface covering 202 is at an angle to the axis 212 of the sensor for measuring force. For example, the force on the exterior surface covering 202 may be perpendicular to the axis 212 (e.g., have no component of the force parallel or anti-parallel to the axis 212).

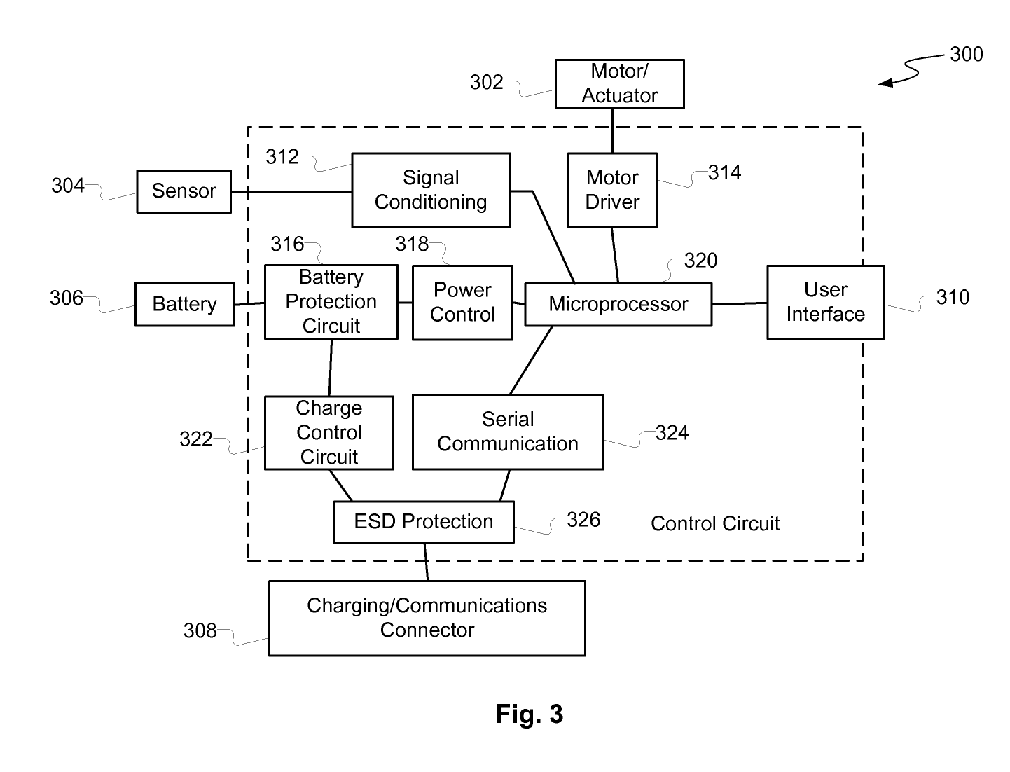

FIG. 3 shows a schematic representation of an exemplary control circuit 300 for a device according to an embodiment of the present disclosure. The exemplary control circuit 300 includes interfaces with other components of the device, including a vibratory element, such as motor 302. For example, a motor 302 may have an offset weighted shaft that causes vibrational movement of the shaft when rotated by the motor.

The control circuit 300 further includes an interface with a sensor 304. For example, the sensor 304 may be a pressure sensor, flow sensor, force sensor, or other sensor as described further herein. In one embodiment, the sensor 304 is mounted on a circuit board with the control circuit 300. In another embodiment, the sensor 304 is physically separated from the control circuit 300. For example, the sensor may be located within a portion of the device near the deformable chamber and may be connected to the control circuit 300 via wire(s).

In one embodiment, the control circuit 300 further includes a signal conditioning circuit 312 for interfacing the sensor 304 with the microprocessor 320. As described further herein, the sensor 304 may be used to measure a pressure, a deformation and/or a flow value (e.g., related to how intensely the user is squeezing the deformable chamber). In one embodiment, the signal conditioning circuit 312 is used to clean up (e.g., filter, remove noise, remove voltage spikes), amplify, and/or otherwise modify the signal received from the sensor 304 before the signal is sent to the microprocessor 320.

The control circuit 300 further includes a user interface 310. The depiction of the user interface 310 separated from sensor 304 describes only one embodiment, and may be useful for some descriptions herein. In one embodiment, the user interface 310 includes input devices that are separate from the sensor 304. In another embodiment, the user interface 310 comprises or is integrated with the sensor 304, thereby forming a unified input/control interface for the user.

In one embodiment, the user interface 310 includes two buttons, such as a power button and a mode button, as described further herein. For example, the mode button may allow a user to select between three modes, including a real-time mode, a record and repeat mode (a “parrot” mode), and a lock mode, as described further herein. In one embodiment, described further herein, a lock mode may be used to retain the recorded pressure level information and to disregard further input from the pressure sensor. In one embodiment, the user interface 310 includes at least one light. For example, a light may be used to indicate a mode of the device, to indicate the presence of a stored sequence of pressure levels, the power level of the battery, battery charging status, and/or to request further input from the user. For example, the light may be positioned near a user interface 310 or near a sensor 304, such as within the deformable chamber, as described further herein.

Control circuit 300 includes a microprocessor 320. Microprocessor 320 may be substituted in some embodiments with a microcontroller, ASIC, FPGA, system on a chip (SoC), or other processor or electronic device capable of processing instructions and/or signals. In one embodiment, the microprocessor 320 receives input from the user interface 310 and the sensor 304, maintains mode status information (e.g., state machine information) and controls the system outputs, including directions to motor driver circuit 314 for controlling the motor 302, as described further herein. In one embodiment, the microprocessor 320 manages communication with an external computer or other device via the serial communication device 324, such as a Universal Serial Bus (USB) or other serial connection. In another embodiment, the microprocessor 320 may communicate with a computer or other electronic device via wireless communication.

The control circuit 300 further includes the motor driver circuit 314 in connection with the microprocessor 320. The motor driver circuit 314 converts signals from the microprocessor 320 into signals sufficient to operate the motor 302 according to commands from the microprocessor. In one embodiment, the motor driver circuit 314 provides power modulation of the signal from a low power signal to a high power signal. In another embodiment, the motor driver circuit 314 includes protection elements (e.g., capacitors, inductors) to reduce the effects of switching power to the motor. In one embodiment, the microprocessor 320 produces a pulse width modulated (PWM) signal that is suitable for driving the motor (e.g., PWM frequency is much greater than motor's response) with a continuously-variable power given only two possible voltage outputs and the motor driver circuit 314 receives this PWM signal and amplifies the signal (e.g., in voltage, in current) to a suitable signal for driving the motor. In another embodiment, the motor driver circuit 314 produces a PWM signal from instructions from the microprocessor 320. As described further herein, the microprocessor 320 may instruct the motor driver circuit to provide power to the motor through many different types of sequences and/or modulation schemes.

The control circuit 300 further includes an interface with a battery 306 for providing power to the control circuit and/or other elements of the device 100. The control circuit 300 further includes an interface with a connector 308 of the device for charging the battery and/or communications. In one embodiment, the connector 308 is encased in an exterior surface covering, as described further herein. For example, the device may be covered by a waterproof surface covering and the connector may allow the battery 306 to be charged through an inductive coupling and/or may allow communications through electromagnetic radiation. In another embodiment, the connector 308 provides surface contacts, such as metallic contacts, for direct physical connection.

In one embodiment, the device may be charged via the connector 308, for example, a 4-pin customized magnetic charge cradle connector. In one embodiment, the connector 308 can also be used to establish a serial or USB connection (with an appropriate connecting cable). For example, the device may connect (e.g., communicate) with external devices for purposes including, but not limited to, remote control of the device and transfer of firmware and/or usage information (e.g., recorded usage, sensed pressure levels, sequences of pressure levels). In some embodiments, as described further herein, the connector 308 may be adapted for connection through physical, wireless, and/or inductive coupling. In one embodiment, the connector 308 is separated from the control circuit 300 and is connected thereto via wire(s).

The control circuit 300 contains electrostatic discharge (ESD) protection 326 of the connector 308 to limit damage to the control circuit from electrostatic discharges, such as the charging and/or communications occurring through the connector, from user handling of the device, or from effects from the environment in which the device is placed. The control circuit 300 includes a charge control circuit 322 and battery protection circuit 316 that interface with the connector 308 to manage the use of the battery 306. For example, the charge control circuit 322 and/or battery protection circuit 316 may be used to control the charging of the battery 306 (e.g., from a charge source via an external power adaptor) and the discharging of the battery (e.g., during operation, during transfer of information to/from the device). In one embodiment, the charge control circuit 322 and battery protection circuit 316 are adapted to operate independently from the microprocessor 320. In another embodiment, the charge control circuit 322 and battery protection circuit 316 are monitored by the microprocessor 320 and/or provide certain functionality to the control circuit 300 only when controlled by or in communication with the microprocessor.

The control circuit 300 contains power control circuit 318. In one embodiment, the power control circuit 318 controls the power consumption during various modes of operation of the device, such as on-off-sleep modes of the device. For example, the power control circuit 318 may reduce power consumption to the order of tens of micro-amps when the device is in an “Off” state and turn the device “On” when the user actuates a power button through the user interface 310. In one embodiment, the power control circuit 318 may respond to input from the microprocessor 320 without regard to user input through user interface 310.

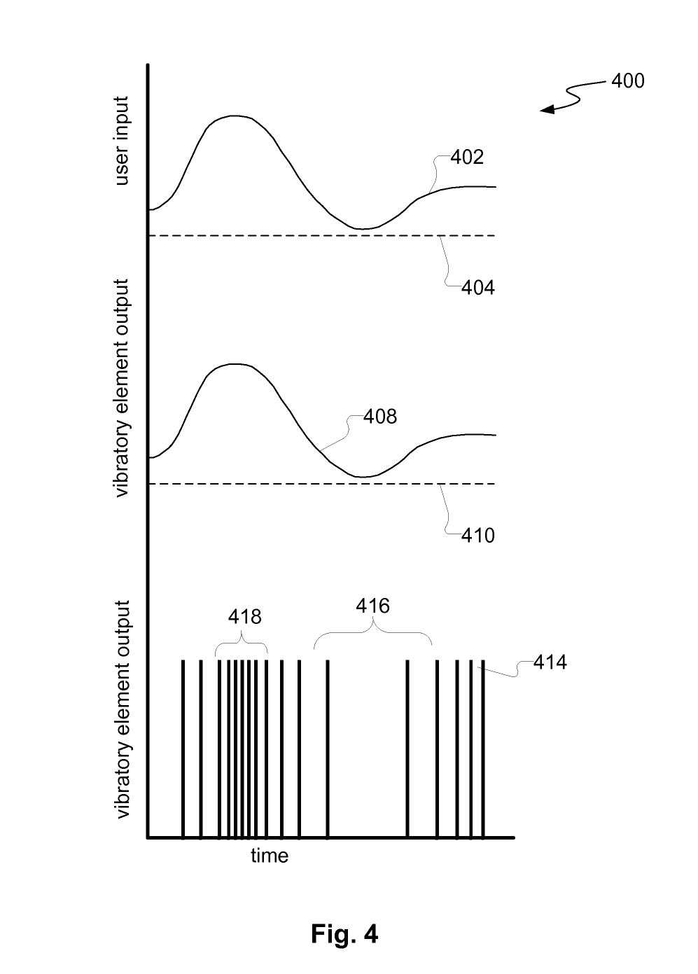

FIG. 4 shows exemplary control of vibratory element of a massage device based on pressure level input. In one embodiment, the vibratory element may be controlled in response to the sensor of the massage device. For example, the vibratory element may be controlled in real-time (or near real-time) with a sequence of power levels delivered to the vibratory element equal to a modified (e.g., amplified, with circuit-induced delay) version of a present pressure sequence sensed in the deformable chamber of the massage device. In one embodiment, the vibratory element is controlled through delivered power level that is proportional to the pressure level sensed by a sensor in contact with the deformable chamber. Proportional control of power delivered to the motor may be provided within certain upper and/or lower limits. In another embodiment, the pressure level is transformed and/or interpreted into another signal that is then used to drive power to the motor. For example, a varying pressure sequence may vary pulses of power to the motor at a frequency or frequencies that are low enough to cause variations in vibration intensity from the motor that are noticeable to a user of the massage device 100.

The upper graph section shows an exemplary user input of a pressure level sequence 402 with a defined baseline 404. In one embodiment, baseline 404 may represent a pressure that the massage device (e.g., sensor and/or microprocessor) determines exists when no deformation of the deformable chamber exists, such as when the deformable chamber is subjected to no user input or otherwise is in an undeformed state. For example, the baseline 404 may be determined by the massage device to be equal to an atmospheric pressure. As another example, the baseline 404 may be set at a certain level for a particular purpose, such as calibrating to a user and/or an environment.

In one embodiment, the massage device in a real-time mode operation will output power to the vibratory element (e.g., a motor) proportionally in response to the user input 402, such as in vibratory element output 408. For example, in operation, a microprocessor may sample the output from a pressure sensor and convert that data (e.g., scale it proportionally) into an output to a motor control circuit. In one embodiment, the microprocessor performs this operation in “real-time.” For example, the microprocessor may limit the delay from input to output to a minimum or under a threshold delay perceivable by a user. In one embodiment, the threshold delay is 10 ms. In another embodiment, the microprocessor samples at a frequency that is fast enough such that it is not noticeable by a user. For example, the microprocessor may sample at a rate (e.g., 1 kilohertz, multiple kilohertz), that allows undetectable delays (e.g., below the threshold) for the “real-time” response for the user, such as 1 ms, or 0.5 ms. As another example, delays may be inserted in order to enhance the user's experience, such as to limit false ends and/or beginnings of recorded sequences, as described further herein.

In one embodiment, the massage device in a real-time mode operation will output power to the vibratory element in response to the user input after a transformation that, at least in some aspects, is not proportional to the pressure sequence input. For example, a vibratory element output may include interpretations of the user input such as smoothing, clipping, or filtering to modify user input into an intended output (e.g., a more pleasing output, an output without discontinuities). For example, as described further herein, an input pattern may be transformed into an output through repeatedly looping the input pattern, and each repetition may be linked by a smoothed, clipped, filtered or otherwise modified (e.g., non-proportionally to the input) portion of the input sequence. As another example, vibratory element output 414 includes a train of pulses that are repeated at a low enough frequency or frequencies such that the vibrational response of the motor is perceived as pulsing (e.g., intensity or frequency of vibrations of a motor rising and falling on a perceivable time frame). A pulse or a train of pulses may comprise a rapidly rising intensity (e.g., of vibration, of power delivered to a vibratory element) to an intensity level for a brief period of time followed by a rapid declining intensity. Each pulse may be distinguishable from the other pulses. In one embodiment, the intensity of a pulse will decrease to a baseline before rising again. For example, the baseline may be a zero or null intensity. In another embodiment, the intensity of a pulse can decrease to a moderate intensity (e.g., based on a motor response) before rising again. For example, pulses may be allowed overlap and/or merge as their frequency increases.

In one embodiment, the amplitude of the pressure level received at the pressure sensor is transformed into a train of pulses. In one embodiment, the train of pulses contains a number or frequency of pulses proportional to the magnitude of the pressure input. For example, the group of pulses 418 may be delivered in response to a high pressure phase of the user input 402 and the group of pulses 416 may be delivered in response to a lower pressure phase of the user input. In another embodiment, the train of pulses contains pulses with an amplitude proportional to the magnitude of the pressure input. In another embodiment the train of pulses contains pulses with some combination of proportional amplitude and frequencies. Each of the pulse trains shown include aspects that may be proportional to the user input 402 and aspects that are not proportional. In one embodiment, the massage device may produce a vibrational output in “real-time” mode that is governed by a transformation that is not proportional to the user input 402.

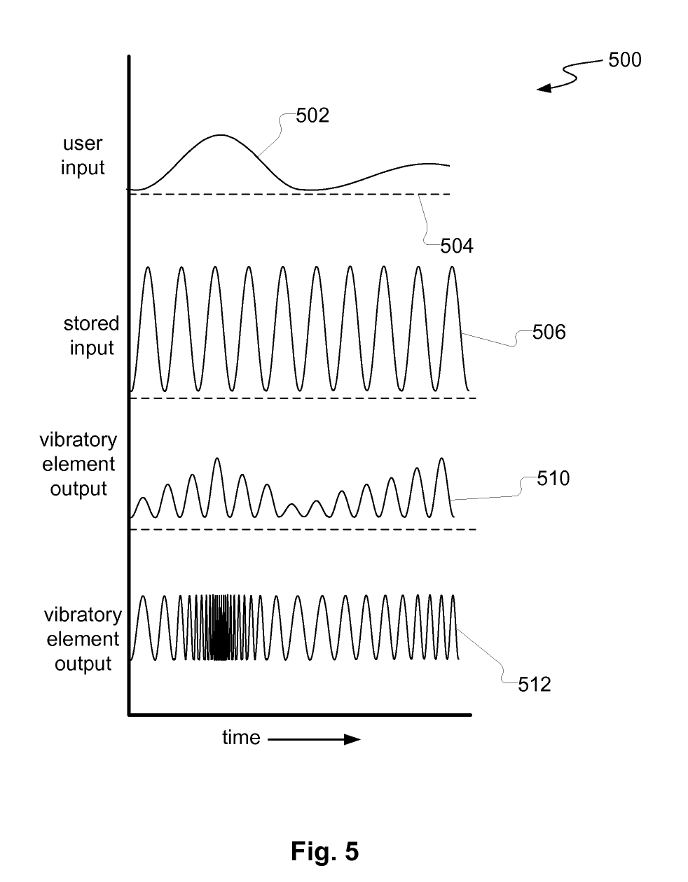

FIG. 5 shows exemplary control 500 of vibratory element of massage device based on stored pressure level information 506 and/or based on current pressure level input 502. In one embodiment, the stored pressure level information 506 may be stored in the massage device based on a user's pressure level input (e.g., through a deformable chamber of the device). For example, a user may deform a chamber of the massage device through a sequence of pressure levels while the massage device is in a mode that records information about the sequence of pressure levels 506 in memory (e.g., volatile memory, nonvolatile memory). As another example, a user of a massage device may deform a chamber of that massage device, store information about the sequence of pressure levels 506 in memory, and then transmit the information to another massage device for storage, playback, and/or other use of the stored pressure level information. As another example, the stored pressure level information 506 may be stored in a networked data store (e.g., Internet-accessible memory), whereby the massage device may receive stored pressure level information 506 produced by a user of another device (e.g., through deformable chamber pressure level input of another massage device). In another embodiment, the stored pressure level information 506 may be stored in the massage device based on automatically-created information (e.g., stimulated response of a massage device, artificial intelligence/learning of user response patterns), user input other than through a pressure level of a deformable chamber (e.g., through a sequence creation software tool), a networked (e.g., online) collaboration of users, and/or any combination thereof. For example, an online community may share stored patterns (e.g., pressure level information) that may be downloaded to massage devices and that may have been created, for example, through a combination of a software tool and user pressure input (e.g., a software-created sequence modified/modulated by pressure input). As another example, a massage device may receive a sequence or pattern (e.g., pressure level information, power output sequence information) from a person intending to give the particular sequence or pattern to the user of the massage device as a gift. For example, a massage device may receive the sequence or pattern from another person or entity other than the user.

In one embodiment, the massage device has a store and playback mode, whereby stored patterns may be retrieved (e.g., from memory) after a period of not playing the pattern, for example, after playing another pattern or after cycling power of the massage device (e.g., turning off and then on). In one embodiment, the store and playback mode is triggered by a button, switch or other user input. For example, the user input may be triggered by a user after creating a pattern that the user wants to save for another time, such as in one of several locations in memory. As described further herein, the stored pattern or sequence of input information (e.g., pressure level information) may be limited by the available memory and the memory may allow practically unlimited and/or expandable memory options. In one embodiment, in order to retrieve a pattern that has been saved, the deformable chamber may be used to toggle, scroll through or preview stored patterns.

In one embodiment, in a store and playback mode of the massage device, the stored pressure level information 506 may be transformed (e.g., modulate, modify, and/or manipulated) by the current pressure level information 502 before the stored information is output to the motor in the form of power levels, as described further herein. For example, the massage device may manipulate the stored information 506 using the current pressure level as a parameter for implementing frequency modulation 512 or amplitude modulation 510. As another example, the massage device may convolve, multiply, divide, add or subtract or otherwise combine the stored information with the current information. For example, the massage device may output a stored pattern (e.g., of pressure information) modified by the current information, thereby allowing a user to change the stored pattern, combine present input information with the stored pattern, or have present information modified (e.g., controlled, confined, or modified by a stored information sequence) by stored information.

In one embodiment, the massage device has different or distinct playback transformation modes whereby the massage device uses current input information (e.g., pressure level) to transform the stored information (e.g., pressure level sequence) in frequency, in amplitude, in phase or in a combination thereof. In one embodiment, the massage device manipulates the stored information differently based on the playback transformation mode selected. For example, a first playback transformation mode may manipulate the frequency or time basis of the stored information. As another example, a second playback transformation mode may manipulate the amplitude or phase of a sequence of stored information. As another example, a third playback transformation mode may add or subtract the stored information and the current information. As another example, a fourth playback transformation mode may play the stored information backward or reverse order.

As one example, in a playback and addition mode, the present information adds amplitude and frequency content to the previously stored information. This mode is similar to layering a beat or rhythm on top of a bass line in music.

As another example, in a playback and subtract mode, the present information subtracts amplitude and frequency content to the previously stored information, or the previously stored information subtracts from the present information. This mode is similar to addition, but instead of combining the stored information with real-time input, the real-time input removes amplitude from the saved sample at that time in the sample. In one embodiment, the stored information is subtracted from the current information. In another embodiment, the current information is subtracted from the stored information.

In one embodiment, the massage device has a re-record mode whereby the massage device will record, as described further herein, the result of combining the stored information combined with or modified by the current information (e.g., pressure information). For example, the massage device may record the played back composite of the stored information and current information (e.g., power output sequence information) in another portion of memory while keeping the stored information in the memory. As another example, the massage device may record the played back composite over the presently-stored information (e.g., in the same memory location, thereby overwriting it).

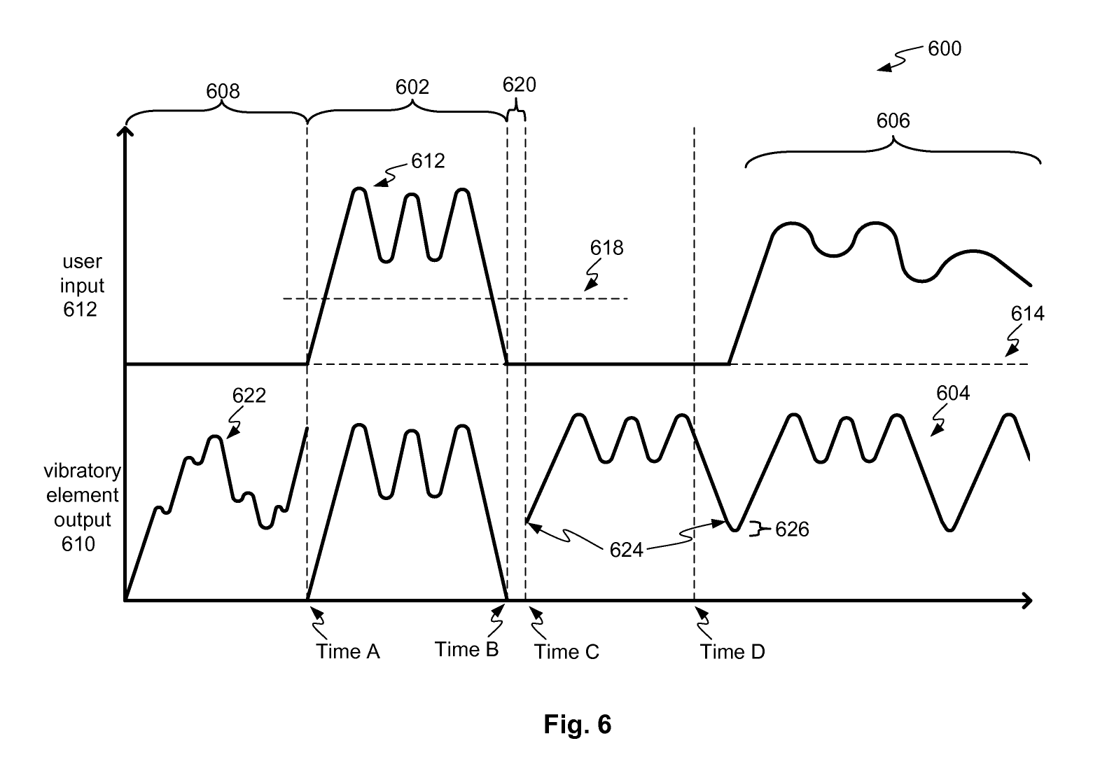

FIG. 6 shows exemplary control 600 of power delivered to a vibratory element 610 of a massage device based on current pressure level input 612 and delayed versions of recent pressure level input. In one embodiment, the massage device has one or more of three “short-term memory” modes for operation, namely a “free play” mode (e.g., a zero-memory mode), a “record and repeat” mode and a “lock” mode, which may be selected, for example, by pressing a button or operating a switch. For example, there may be a button where each press moves the massage device into the next mode. In one embodiment, a short-term memory mode may provide memory storage for only recently input information (e.g., pressure information). For example, as described further herein, a record and repeat mode may only repeat the most recently input sequence of pressure level information, and a lock mode may only continue to repeat the recently input sequence, disregarding new input.

In one embodiment, the massage device has a “free play” mode that, as described further herein, provides real-time response to pressure applied to deformable chamber. For example, the real-time response to the pressure in the deformable chamber may be proportional control of power delivered to the vibratory element. As another example, the real-time response may be a proportional frequency of pulses (e.g., each of duration and amplitude noticeable to the user). As another example, the real-time response may be a modification of a baseline vibratory pattern, such as amplitude modulation.

As shown in FIG. 6, during the time shown in section 602 (between time A and time B) shows the response of the vibratory element output 610 in real-time to the user input 612. As described further herein, the response during section 602 may be the same in a real-time mode and in a record and repeat mode based on the current user input shown in section 602.

In one embodiment, the massage device has a “record and repeat” mode that captures a running sequence of user input 612 (e.g., pressure level information from the deformable chamber) and plays it back in a continuous loop manner 604. In one embodiment, in the record and repeat mode the device is constantly “listening” to new pressure input (e.g., when the pressure in the deformable chamber exceeds a baseline 614 or a threshold level 618 above a baseline), and any new input will overwrite the previous loop with the new pattern. For example, section 608 (before time A) may represent a previously recorded sequence being repeated until, at time A, new pressure level input (e.g., above a baseline pressure level 614) is sensed, as described further herein. In one embodiment, as soon as the new input pressure level information is received (e.g., time A), the massage device switches from repeating the previous loop (e.g., without a noticeable delay, less than 1 ms, at a sampling period of the microprocessor) and begins real-time vibration response. In one embodiment, when the user input 612 (e.g., pressure level) again returns to a baseline 614 or a threshold level 618 above a baseline, the massage device stops recording and switches back to repeating the sequence that was just input to the device.

In one embodiment, in record and repeat mode, there is a delay 620 (e.g., between time B and time C) after the deformable device returns to a baseline 614 or a threshold level 618 above a baseline before the massage device stops recording pressure level input information and begins repeating the recorded pressure level information. For example, this delay 620 may allow the user to insert pauses in the recorded and repeatedly looped pattern. As another example, this delay 620 may be sufficient to eliminate “false ends” where the user creates a baseline or near baseline pressure level for a brief period of time without intending to stop the recording cycle. In one embodiment, the massage device records through about 1 second of delay 620 between when the pressure input stops (e.g., is at a baseline 614 or threshold 618 above a baseline level) to when the repeated looping commences. In another embodiment, the massage device records through 0.5 seconds of delay 620. In another embodiment, the massage device records through 100 milliseconds of delay 620.

In one embodiment, the massage device or the control circuit thereof may modify the recorded pressure level sequence in order to create a sequence that repeats in an expected manner. For example, a pressure level sequence may be repeated with modified portions in order to create a smooth repeated pattern, such as through removing or truncating portions of the pressure level sequence that reach a baseline 614, or reach levels below a threshold 618 above a baseline. As another example, a pressure level sequence input may be interpreted by the massage device as being constant, based on an interpretation of the input as maintaining a constant value with only human-control-induced errors, variations, ramp-up or ramp-down periods, and/or glitches. In one embodiment, an input sequence may be modified (e.g., filtered) based on a presumption about the input sequence and/or based on a stored/learned behavior of the user. In another embodiment, the pressure level sequence is repeated in complete form, such as the sequence was input between time A and time B. In one embodiment, the massage device only repeats the sequence as input between time A and time B while the pressure level sequence was above a threshold 618 above the baseline 614. For example, the pressure level input sequence or pattern 612 may be truncated at points 624 where it crossed a threshold 618 above a baseline 614. In another embodiment, the threshold 618 is different for the time when the pressure level input pattern crosses a first threshold from below and when it crosses a second different threshold from above.

In one embodiment, the massage device may create a transition pattern or sequence 626 (e.g., as a power output pattern, a sequence of power) adapted to transition between the beginning and ending points of the pressure level input pattern 612. For example, the transition sequence 626 may be adapted to provide a smooth transition of power levels between truncated points 624 of the input pattern, such as to provide a continuous first derivative of the power level sequence 604 when the sequence is repeated. As another example, a transition sequence 626 may be adapted to provide a continuous second derivative of the power level sequence 604 when the sequence is repeated. As another example, a transition sequence 626 may be adapted to provide a continuous third or higher derivative of the power level sequence 604 when the sequence is repeated.

In one embodiment, a threshold 618 can be modified by the massage device (e.g., by a control circuit therein) based on the pressure level input being largely constant during the sequence. For example, the massage device may truncate an input pressure level sequence to include only a constant pressure level portion or only a relatively-constant pressure level portion when, apart from a rise in pressure from baseline and fall in pressure back to the baseline, the pressure level sequence is largely constant. For example, a threshold 618 may be established (e.g., in response to pressure level input) to eliminate the rising and falling portions of a pressure level input based on a received input pressure level sequence including a relatively-quick rise to a constant pressure level and subsequent fall from that constant pressure level. The threshold may be established such that only the relatively constant portion of the sequence is repeated, as described further herein.

In one embodiment, the memory of the massage device has a limit of record time, such as 10 seconds. In one embodiment, when a pressure input pattern 612 (e.g., in section 602 between time A and time B) is longer than the time that can stored in memory, only the last segment input to the device and stored into memory (e.g., 10 seconds, 1 second) is looped when the pressure reaches a baseline 614 or threshold above a baseline 618. In one embodiment, the massage device includes a port for accepting additional memory (e.g., solid state memory). In one embodiment, the massage device may accept an instruction determining the length of the segment of memory to loop. For example, an input device may be used by a user to select the size of a portion of memory to be devoted to recording the most recent input and storing it for repeated looping playback after the pressure input is returned to a baseline or a threshold above a baseline.

In one embodiment, the massage device has a “locked” mode (e.g., at least after time D) that disregards further pressure input 606 and continues to repeat the last input before entering the locked mode (e.g., sometime before time D). For example, this embodiment allows a pattern to be repeated without interruption by accidental pressure input. In one embodiment, the massage device may enter lock mode only from the record and repeat mode, thereby continually repeating the previous pattern in a loop until the massage device exits the lock mode and ignoring any further pressure input.

In one embodiment, the locked mode may allow further pressure input to transform, as described further herein, the repeating previous pattern with current input (e.g., pressure level). Such a transformation in locked mode is not shown in FIG. 6, but may be similar to transformations shown and described further herein. For example, the locked mode may allow modifications by further current input after the locked mode is entered. In one embodiment, the locked mode will repeat the original recorded sequence (e.g., from section 602) if the current pressure returns to a baseline 614 or a threshold above a baseline 618 (e.g., keep the original record and repeat sequence intact in memory). In another embodiment, the locked mode will repeat the original recorded sequence (e.g., from section 602) as modified by the later input sequence 606 if the current pressure returns to a baseline 614 or a threshold above a baseline 618 (e.g., replace the original record and repeat sequence in memory with the newly-modified sequence).

It is clear that many modifications and variations of this embodiment can be made by one skilled in the art without departing from the spirit of the novel art of this disclosure. For example, the systems and method herein disclosed can be applied to controlling other devices (e.g., user-operated, body-operated, handheld) based on sensed user feedback. Also, while specific pressures, device configurations, time values, time periods, and thresholds may have been disclosed, other reference points can also be used. These modifications and variations do not depart from the broader spirit and scope of the present disclosure, and the examples cited here are illustrative rather than limiting.

What is claimed is:

1. An apparatus comprising:
a deformable surface portion;
a deformable chamber connected with the deformable surface portion;
a pressure sensor configured to detect a pressure level of the deformable chamber;
a vibratory element; and
a control circuit adapted to control power delivered to the vibratory element based on the pressure level.

2. The apparatus of claim 1, wherein the deformable chamber is continuously variable in deformation between a first deformed state and a second deformed state, and wherein the deformable chamber is adapted to vary continuously the pressure level in response to a continuous deformation between the first deformed state and the second deformed state.

3. The apparatus of claim 1, wherein the control circuit is further adapted to control continuously the power delivered to the vibratory element based on a continuous variation of the pressure level.

4. The apparatus of claim 1, wherein the deformable surface portion has a surface normal, and wherein the pressure sensor is further configured to detect the pressure level of the deformable chamber along an axis that is at a first angle greater than zero degrees to the surface normal.

5. The apparatus of claim 1, wherein the pressure level is a first pressure level of a sequence of pressure levels, and wherein the control circuit is further adapted to control the power delivered to the vibratory element according to the sequence of pressure levels.

6. An apparatus comprising:
a pressure sensor configured to detect a pressure level;
a vibratory element;
a control circuit adapted to control power delivered to the vibratory element based on the pressure level; and
wherein the pressure level is a first pressure level of a sequence of pressure levels and wherein the control circuit is further adapted to store pressure level sequence information in a memory.

7. The apparatus of claim 6, wherein the control circuit is further adapted to sense the sequence of pressure levels being equal to a predetermined level for a predetermined period of time, and in response thereto, to repeatedly control power delivered to the vibratory element based on the sequence of pressure levels before it became equal to the predetermined level for the predetermined period of time.

8. The apparatus of claim 6, wherein the control circuit is further adapted to receive the pressure level sequence information from the memory of the apparatus and wherein the control circuit is further adapted to control the power delivered to the vibratory element according to a combination of the pressure level sequence and a current pressure level.

9. The apparatus of claim 8, wherein the combination is the pressure level sequence with a time period modified from an original time period by the current pressure level.

10. The apparatus of claim 8, wherein the combination is the pressure level sequence with an amplitude modified from an original amplitude by the current pressure level.

11. The apparatus of claim 8, wherein the current pressure level is one of a current sequence of pressure levels, and wherein the combination is the pressure level sequence summed with the current pressure level sequence.

12. The apparatus of claim 6, wherein the control circuit is further adapted to request the pressure level sequence information from the memory of the apparatus and wherein the control circuit is further adapted to control the power delivered to the vibratory element according to the pressure level sequence based on the pressure level being at a baseline pressure for longer than a predetermined time.

13. The apparatus of claim 12, wherein the apparatus includes a deformable chamber and the pressure level being at the baseline pressure corresponds to the deformable chamber being in an undeformed state.

14. A method comprising:
sensing a sequence of pressure levels within a deformable chamber of a vibratory device;
in response to sensing the sequence, controlling power to a vibratory element of the vibratory device with a power sequence based on the sequence of pressure levels;
after sensing the sequence of pressure levels, sensing a pressure level equal to a predetermined level; and
in response to on sensing the pressure level equal to the predetermined level, repeating the step of controlling the power to the vibratory element of the vibratory device with the power sequence.

15. The method of claim 14, further comprising:
creating a transition sequence of power levels that forms a smooth transition between repeated power sequences;
controlling power to the vibratory element with the transition sequence inserted between repeated power sequences.

16. The method of claim 14, further comprising:
truncating the power sequence repeated during the repeating step based on the sequence of pressure levels falling below a predetermined threshold above the predetermined level.

17. The method of claim 14, further comprising:
retrieving a stored sequence of pressure levels from a memory of the vibratory device;
wherein controlling the power to the vibratory element is performed based on the stored sequence of pressure levels as modified by the sequence of pressure levels.

18. The method of claim 17, wherein the stored sequence of pressure levels is modified with a new time period modified from an original time period by the sequence of pressure levels.

19. The method of claim 17, wherein the stored sequence of pressure levels is modified with a new amplitude modified from an original amplitude by the sequence of pressure levels.

20. The method of claim 17, wherein the stored sequence of pressure levels is summed with the sequence of pressure levels.
